(19) United States
(12) Patent Application Publication
(10) Pub. No.: US 2013/0115527 A1
(43) Pub. Date: May 9, 2013

(54) Rechargeable lithium air batteries

(71) Applicant: Ming Au, Martinez, GA (US)

(72) Inventor: Ming Au, Martinez, GA (US)

(73) Assignee: SAVANNAH RIVER NUCLEAR SOLUTIONS, LLC, AIKEN, SC (US)

(21) Appl. No.: 13/288,583

(22) Filed: Nov. 3, 2011

(51) Int. Cl. H01M 4/86; H01M 8/22; B82Y 30/00

(52) U.S. Cl. 429/405; 429/534; 977/742; 977/811; 977/780; 977/762

(57) ABSTRACT

A rechargeable non-aqueous lithium-air battery is provided having a multilayered cathode structure which uses a functionized carbon paper base with tubular catalysts. The multilayer cathode has a sufficient pore size to prevent clogging of the cathode by reaction products and further has a hydrophobic coating to repel moisture. The stable electrolyte is made by ionic liquid and additives which have no reaction with discharge products and offers solubility for oxygen and lithium oxide.

### STATEMENT AS TO RIGHTS TO INVENTIONS MADE UNDER FEDERALLY SPONSORED RESEARCH AND DEVELOPMENT

This invention was made with Government support under Contract No. DE-AC09-08SR22470 awarded by the United States Department of Energy. The Government has certain rights in the invention.

### FIELD OF THE INVENTION

This invention is directed towards a rechargeable non-aqueous Li-air battery. In particular, the invention relates to a Li-air battery with novel multilayered cathode architecture which uses a functionized carbon paper having associated therewith a plurality of hollow tubular catalyst which further uses a hybrid electrolyte made by an ionic liquid and additives. The resulting battery demonstrates a high-energy storage capacity and a long charge-discharge life.

### BACKGROUND OF THE INVENTION

Numerous efforts have been made to develop advanced batteries having high-energy storage density, low cost, and safety. One commercial driver for such developments has been with respect to electric and hybrid vehicles.

Li-Air batteries have been envisioned because of the high theoretical energy storage capacity of 13 kWh/kg which is approximately 100 times greater than current Li-ion rechargeable batteries having a storage capacity of 0.135 kWh/kg. One problem with respect to Li-air batteries is the violent reaction of water and lithium. It has also been proposed that non-aqueous Li-air batteries using a polymer electrolyte might be possible but such approaches have been met with limited success due to limited solubility of oxygen in non-aqueous electrolyte and the pore clogging by precipitation of insoluble discharge products such as Li₂O and Li₂O₂. The carbonate based non-aqueous electrolytes used currently are instable. They not only evaporate from the cell over time, but also decompose through the reaction with lithium oxide radicals forming stable lithium carbonate. Both the evaporative loss and the decomposition of electrolyte prevent the Li-air battery from being rechargeable.

These technical challenges to Li-air batteries need to be simultaneously addressed.

Accordingly, there remains room for improvement and variation within the art.

### SUMMARY OF THE INVENTION

It is one aspect of at least one of the present embodiments to provide for a Li-air battery having multi-layered cathodes fabricated on a carbon paper based substrate that can be manufactured through a room temperature filtration process without use of binders and conductive additives.

It is a further aspect of at least one embodiment of the present invention to provide for Li-air battery in which a multilayered carbon cathode is provided having a gas diffusion layer and an electrochemical reaction layer.

It is a further aspect of at least one embodiment of the present invention to provide for an electrochemical reaction layer in a Li-air battery consisting of carbon nanofiber, carbon nanotubes and nanostructured catalysts.

It is a further object of at least one aspect of the present invention to provide for a carbon paper substrate for a cathode having a surface functionalized so as to form functional groups capable of chemical binding with hydrophobic coating agents for repelling moisture.

It is a further aspect of at least one embodiment of the present invention to provide for a cathode having a moisture repelling surface and an opposite surface having a plurality of carbon nanostructures cross-linked to the carbon paper, thereby providing electrical conductivity and enhanced chemical integrity to the carbon paper.

It is a further object of at least one aspect of the present invention to provide for a Li-air battery cathode having a gas diffusion layer comprising a mixture of carbon nanofibers, carbon nanotubes, carbon black, and catalysts that is homogeneously applied to the carbon paper so as to form an interlocked network. One suitable process for applying the gas diffusion layer includes a liquid filtration process. The gas diffusion layer has a pore size in the range of 0.01 μm to 0.1 μm that enables the oxygen from ambient air to be intaken during discharge and with oxygen vented from the cathode during recharge.

It is a further aspect of at least one embodiment of the present invention to provide for a process of forming a electrochemical reaction layer that has a pore size in the range of 10 nm to 100 nm that enable formation of a gas-liquid-solid tri-phase in the region where electrochemical reactions are taking place. The pore size, pore distribution, surface area, and electrochemical activity of the electrochemical reaction layer can be varied by selection of the types and mixing ratio of the carbon nanofibers, carbon nanotubes, carbon black, and catalysts.

It is a further object of at least one aspect of the present invention to provide for a Li-air battery cathode having a gas diffusion layer. The gas diffusion layer may be deposited through a liquid filtration process. In so doing, the resulting structure provides for a cathode of a Li-air battery which is capable of delivering a large storage capacity along with repeated charge/discharge recycling.

It is a further aspect of at least one embodiment of the present invention to provide for a Li-air battery which comprises a non-aqueous electrolyte with low vapor pressure providing sufficient ion conductivity and oxygen solubility and which undergoes no side reaction with lithium oxide radical.

It is a further aspect of at least one embodiment of the present invention to provide for carbon base multilayered cathode having a high porosity and a suitable pore size to accommodate insoluble discharge products Li₂O and Li₂O₂ during discharge and meanwhile permitting the continuous availability of oxygen to the Li ion dissolved in electrolyte. The precipitates of discharge products Li₂O and Li₂O₂ will be reduced to Li ions and oxygen during recharge under the electrochemical driving force and assistance of the catalysts. Hence the occupied pores will be freed.

Accordingly, there remains a need in the art for a novel catalyst to be developed to facilitate oxygen reduction in discharge and evolution in recharge. It is a further aspect of at least one embodiment of the present invention to provide novel catalysts with square tubular structure that provides a large specific surface area, both interior and exterior, and an interlocking capability with carbon nanofiber and nanotube to be embedded in cathode. Since the redox reaction Li+O₂<->Li₂O/Li₂O₂ takes place only in a gas (oxygen)-liquid (electrolyte)-solid (catalyst) co-existing area of the cathode, such requirements necessitate a cathode to be constructed with a unique architecture to enable the maximum triphase area to be provided. The air electrode (cathode) must also be moisture repellant while facilitating oxygen intake from the environment.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is a schematic drawing of a multi-layered cathode setting forth a reaction layer, a gas diffusion layer, and a functionized carbon paper.

FIG. 2 is a schematic drawing of a Li-air battery.

FIG. 3 is a graph setting forth the performance of a Li-air battery in a 50 discharge-charge cycle evaluation.

FIG. 4 is a scanning electron micrograph of square nanotubes that may be used to construct a cathode.

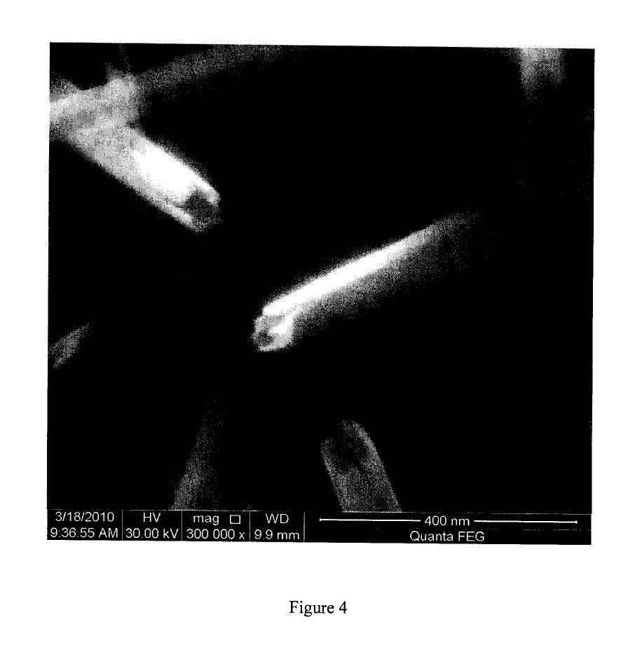

FIG. 5 is a scanning electron micrograph of a cross-section of a multilayered cathode.

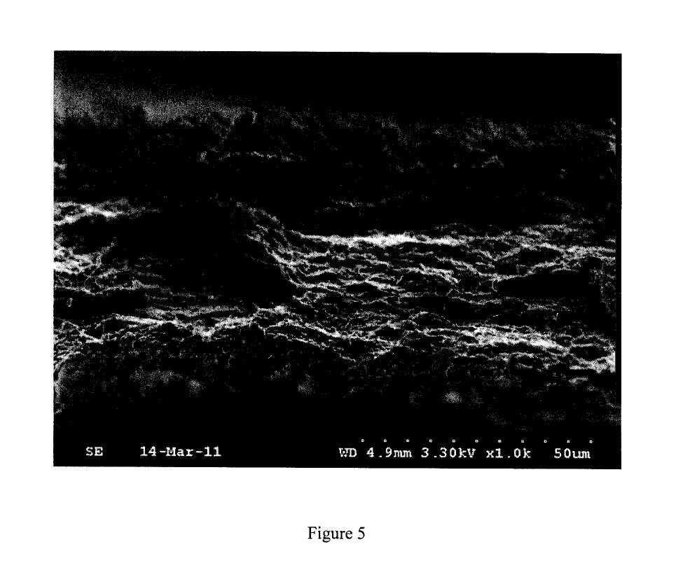

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

A non-aqueous Li/air battery was fabricated by stacking an anode, an electrolyte saturated separator and a cathode in a coin cell case. Li foil disks with a 17 mm diameter were cut from 0.3 mm thick Li ribbon as the anode. The separator disks with 19 mm diameter were cut from Millipore APFF2500 glass fiber filters with 0.38 mm thickness, 0.7 μm pore size and 90% porosity. The separator disks not only insulate the electron flow but also provide a reservoir for storage of electrolyte. The large pore size and high porosity permits precipitates of lithium oxides in the separator while still providing sufficient vacant pores for oxygen and lithium ions shuttling. It is also found that the prior art membranes such as polyethylene membranes (Celgard 2400) having a thickness of (25-50 μm), a pore size of (0.04-0.12 μm) and porosity of (37%) are collectively too small to hold sufficient electrolyte. The small pore volume of prior art membranes will be filled by lithium oxide precipitation that restricts lithium ion diffusion and attributes to the increase of cell impedance, thereby shortening recycling life and are also more subject to side reaction with radicals, ignition and burning hazards.

The multilayered cathodes were made in following procedure: 1) the carbon paper with 0.19 mm thickness (Toray TGP-H-060) and 78% porosity was functionized by treatment in the chemical bath (1 M KOH) under sonication to create surface defects and dangling carbon bonds. One side of the functionized carbon paper was coated by Teflon® PTFE to form porous hydrophobic layer while other side is left uncoated.

A suspension of low surface carbon black (LCB), carbon nanofibers (CNF) and α-MnO₂ nanotubes in dimethyl carbonate (DMC) was poured on the uncoated surface of the carbon paper positioned in the filtration system (Table 1). The catalysts are preferably embedded in the cathode structure so as to be accessible by oxygen and the lithium ions. It is preferred further to use nanoscale hollow and tubular catalyst because of the increased surface areas on both the exterior and interior of the particles as well as for the ability to interlock with one dimensional carbon such as carbon nanotubes and carbon nanofibers. The transition metal oxides and rare earth metal oxides with variable valences are preferable catalysts for oxygen reduction reaction (ORR) and oxygen evolution reaction (OER) and include MnO₂, Fe₃O₄, CO₃O₄, V₂O₅, MoO₂, La₂O₃, Ce₂O₃ and other catalyst according to the formula of MₓO_{y}, where M=Mn, Fe, V, Co, Mo, Ni, Ti, Zr, Cr, Zn, Sn, W, La, Y, Ce, Nb, and x=1-3, and y=1-5.

A homogenous gas diffusion layer (GDL) of LCB+CNF+α-MnO₂ was deposited on the carbon paper. The α-MnO₂ may be in the form of square, rectangle, or similar polyhedron shaped tubes. The second suspension of the high surface area carbon black (HCB), single wall carbon nanotubes (SWNT), carbon nanofibers (CNF) and La₂O₃ tubular nanoparticles in dimethyl carbonate (DMC) was poured on the GDL (Table 1). Through filtration of the second suspension layer, the reaction layer (RL), was formed on the top of the GDL. The reaction layer has a pore size in the range of about 10 nm to about 100 nm.

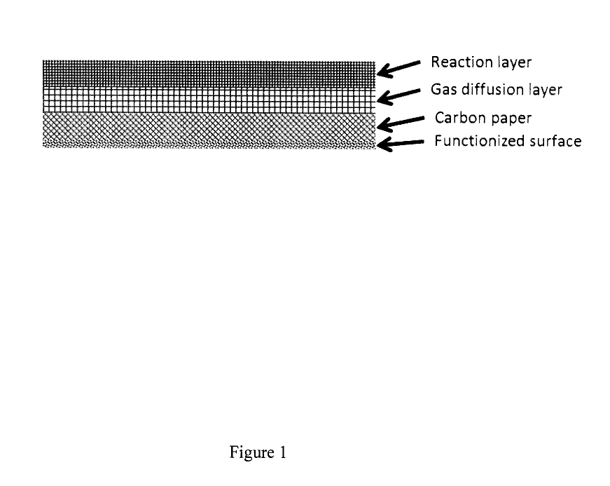

As best seen in reference to FIG. 1, the cathode is constructed on a thin layer of carbon paper. A lower surface of carbon paper has a functionized surface formed by a coating of PTFE to form a hydrophobic layer. The gas diffusion layer is formed in the upper surface of the carbon paper. The gas diffusion layer is provided by carbon nanofibers, carbon nanotubes, carbon black, and catalysts that, when applied to the carbon paper, form an interlocked network and has a pore size of about 0.01 μm to 0.1 μm. The network closest to the carbon paper provides for a gas diffusion layer while an upper surface defines an interlocked reaction layer as described above for the redox reaction associated with the battery. Other catalysts as described herein may be used singly or in combination with other catalysts within either the reaction layer or the diffusion layer. The thickness of the multilayered cathodes is about 0.25 to about 0.30 mm.

The catalyst(s) within the gas diffusion layer facilitates oxygen reduction as molecular oxygen is broken down to oxygen ions. The oxygen ions thus become available for further reaction in the adjacent reaction layer where oxygen ions can be reacted with lithium ions to form lithium oxides Li₂O and Li₂O₂. During recharge, the lithium oxide will decompose to lithium ions and molecular oxygen in the reaction layer. The catalyst α-MnO₂ and other catalysts useful for oxygen reduction reactions are provided in the gas diffusion layer to facilitate the discharge. The La₂O₃ and other catalysts useful for oxygen evolution are provided in the reaction layer to facilitate the recharge.

The multilayered cathode was then removed from the filtration system, rinsed with alcohol and water, dried and cut at 17 mm diameter for assembly. The Li/air batteries are assembled in the glove box filled with argon gas. A stainless case of the 2025 coin battery cell is drilled with 17 holes with 1.5 mm diameter for oxygen communication. The hybrid electrolyte was prepared with mixing ionic liquid, such as 1-butyl-3-methylimidazolium hexafluorophosphate, 1-ethyl-3-methylimidazolium bis(trifluotomethylsulfony)imide, and 1-methyl-3-octylimidazolium bis(trifluoromethylsultony)amide 1-Hexyl-3-methylimidazolium hexafluorophosphate, with additives to improve its ion conductivity, oxygen solubility and viscosity. The lithium salt such as Bis(trifluoromethane)sulfonamide lithium (BTSFL) was dissolve in the hybrid electrolyte at 1M concentration.

Ionic liquids have been found to offer high ion conductivity, low vapor pressure, and thermal and chemical stability. In addition, one having ordinary skill in the art can address the electrochemical properties through use of various additives, such properties including viscosity, ion conductivity, oxygen solubility and solubility to lithium oxide. The additives include the lithium salt (such as LiBr), other ionic liquids (such as 1-Hexyl-3-methylimidazolium hexafluorophosphate), borides (such as Trispentafluorophenylborane).

TABLE 1
The composition of the multilayered cathode

| Layer | Precursor | wt % | M (mg) | Manufacturer |
|---|---|---|---|---|
| Gas diffusion layer | CNF (HT179) | 70 | 42 | Pyrograf |
| | LCB | 20 | 12 | Alfa Aesar |
| | α-MnO₂ | 10 | 6 | In house |
| Reaction layer | CNF (HT179) | 60 | 36 | Pyrograf |
| | HCB (BP2000) | 10 | 6 | Cabot |
| | CNT (BU-202) | 20 | 12 | US Bucky |
| | La₂O₃ | 10 | 6 | In house |

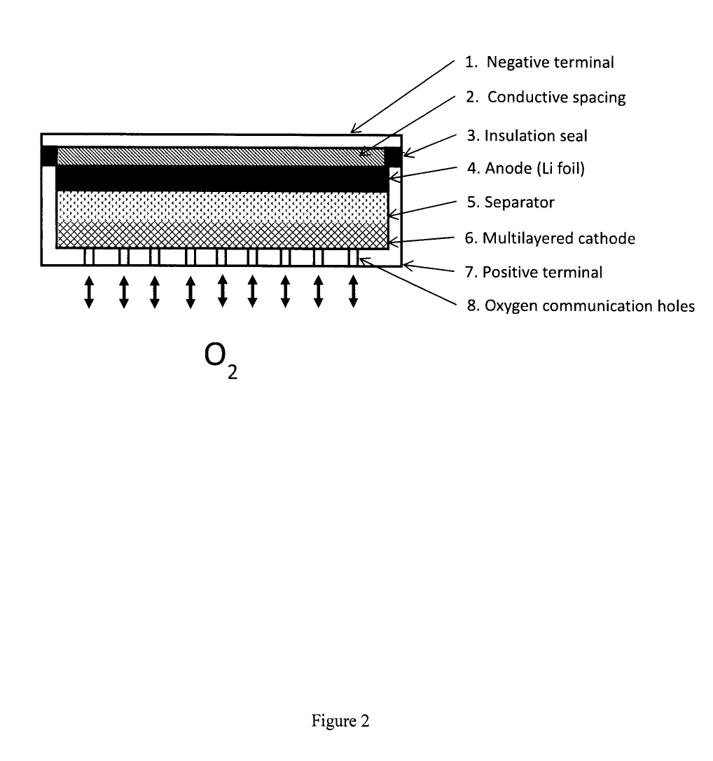

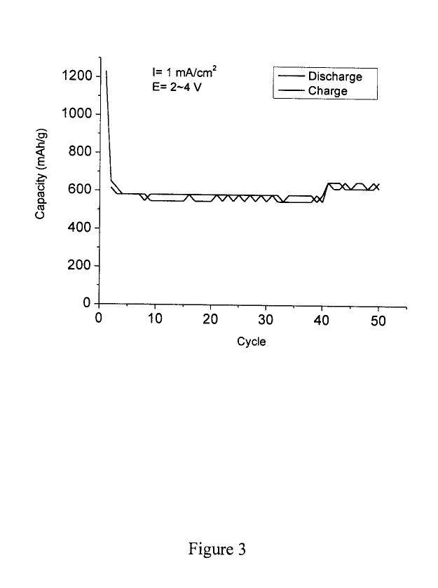

The cathode was placed in a coin cell case with the PTFE coated side facing the communication holes. Then the disks of the glass fiber saturated with hybrid electrolyte and the Li foil were stacked in the case (FIG. 2). The case was sealed for performance testing. The galvanic discharge-charge testing of the 2520 coin cell of the Li/air batter was conducted in the dried gas (21% Oxygen and 79% Argon) at current density of 1 mA/cm² from 2V to 4V. The results show that the cell demonstrated 1200 mAh/g of the first discharge capacity and 600 mAh/g of rechargeable capacity in 50 cycles (FIG. 3).

As further seen in reference to FIG. 2, the Li/air battery comprises a negative terminal having the use of an insulation seal and conductive spacing positioned between the negative terminal and the anode which may be in the form of a lithium foil. A separator layer of a glass fiber mesh is positioned between the anode and the multi-layered cathode. As further seen in reference to FIG. 2, the positive terminal defines a plurality of openings to facilitate the passage of air and oxygen into the interior of the cell.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, or in part. Therefore, the spirit and scope of the appended claims should not be limited to the description of the preferred versions contained therein.

That which is claimed:

1. A lithium-air battery comprising:
a lithium anode;
a separator saturated by an electrolyte having a first side adjacent the lithium anode and a second side adjacent a cathode;
a multilayered cathode comprising a carbon paper substrate, a gas-diffusion layer and a reaction layer.

2. A lithium-air battery according to claim 1 wherein the carbon paper substrate comprises a surface coated with PTFE which is positioned on a side of the cathode opposite the separator.

3. A lithium-air battery according to claim 1 wherein the gas diffusion layer comprises an interlocked mixture of carbon black, single wall carbon nanotubes, carbon nanofibers, and α-MnO₂ nanotubes.

4. A lithium-air battery according to claim 1 wherein the reaction layer comprises an interlocked mixture of carbon black, single wall carbon nanotubes, carbon nanofibers, and La₂O₃.

5. A lithium-air battery according to claim 1 wherein the electrolyte comprises an ionic liquid and additives.

6. A lithium-air battery according to claim 1 wherein the catalysts comprises square nanotubes of metal oxides and metals.

7. A layered cathode for a lithium-air battery comprising:
a carbon paper substrate layer;
a first surface of said carbon paper layer having a coating of PTFE;
a second surface of said carbon paper layer defining a gas diffusion layer formed on an opposite surface of said carbon paper defining said functionized surface, said gas diffusion layer comprising a mixture of carbon black, carbon nanofibers, and nanotubes of alpha-MnO₂;
a reaction layer positioned on top of said gas diffusion layer, said reaction layer comprising a mixture of carbon black, single wall carbon nanotubes, carbon nanofibers, and nanotubes of La₂O₃.

8. The cathode according to claim 7 wherein the gas diffusion layer has a pore size in the range of about 0.01 μm to 0.1 μm.

9. The cathode according to claim 7 wherein said reaction layer retains precipitants of discharge products of Li₂O and Li₂O₂ which will be reduced during recharge to Li ions and oxygen and further defining a pore size in the range of about 10 nm to about 100 nm.

10. The cathode according to claim 7 wherein the cathode has a thickness of about 0.25 to about 0.30 mm.
